(19) United States
(12) Patent Application Publication
(10) Pub. No.: US 2026/0318008 A1
(43) Pub. Date: Oct. 15, 2026

(54) BARRIER COATING STRUCTURE, ITS USE AND A SHEET LIKE PRODUCT

(71) Applicant: Kemira Oyj, Helsinki (FI)

(72) Inventors: Heidi KUHA, Espoo (FI); Anneli LEPO, Espoo (FI)

(21) Appl. No.: 19/485,824

(22) PCT Filed: May 24, 2024
(86) PCT No.: PCT/FI2024/050268

§ 371 Date: Nov. 19, 2025

(30) Foreign Application Priority Data
May 26, 2023 (FI) 20235589

(51) Int. Cl. D21H 21/16; C09D 5/16; C09D 7/63; C09D 101/14; C09D 105/00; D21H 19/12; D21H 19/82; D21H 27/10

(52) U.S. Cl. CPC D21H 21/16; C09D 5/1656; C09D 7/63; C09D 101/14; C09D 105/00; D21H 19/12; D21H 19/824; D21H 27/10

(57) ABSTRACT

The invention relates to a barrier coating structure for a sheet-like substrate comprising cellulosic and/or lignocellulosic fibres. The barrier coating structure comprises at least one first coating layer and at least one second coating layer, wherein the first coating layer is arranged in a direct contact with the second coating layer. The first coating layer comprises α-(1,3→glucan) polymer, and the second coating layer comprises a cellulose ester and a polycarboxylic acid as a crosslinker.

The present invention relates to a barrier coating structure, its use and a sheet like product according to the preambles of the enclosed independent claims.

Due to human population growth and improved living standards, natural resources are facing a risk of depletion. The increasing environmental awareness of consumers, together with emerging governmental regulations, are forcing various industries to replace fossil-based materials with renewable alternatives. Especially in the packaging industry, the interest has focused on materials made from cellulosic fibres, such as paper and board, which are light, biodegradable and recyclable. In food packaging applications, however, materials based on cellulosic fibres face challenges due to their weak barrier properties against water, moisture, grease and oxygen. In order to maintain food quality and safety, packaging materials made from cellulosic fibres require a surface coating which improves the barrier properties of the material. Traditionally, excellent barrier properties have been achieved by extrusion coating the cellulosic fibre material, such as board, with a fossil-based thermoplastic polymer, such as polyethylene (PE). However, the use of fossil-based polymers in coatings reduces the sustainability of the packaging product and may complicate its recyclability. Many traditional fossil-based barrier coatings are problematic to repulp and/or require special process arrangements at repulping. The coatings applied on paper and board should fulfil the requirements of recycling and, for example, they should not disturb the repulping process.

Furthermore, coatings for packaging applications preferably have good resistance for creasing and folding, which means that the applied coating does not crack when the paper or board is folded into a box or wrapped around the product. Cracking may decrease or even completely destroy the barrier properties of the coating.

An object of this invention is to minimise or possibly even eliminate the disadvantages existing in the prior art.

Another object of the present invention is to provide a coating structure and a sheet-like product that are based on renewable raw materials.

Still another object of the present invention is to provide a barrier coating structure and a sheet-like product that provide good barrier properties for water, moisture, oil and grease.

Yet another object of the present invention is to provide a barrier coating structure, which can be used to create a barrier coating that withstands creasing and/or folding without cracking.

These objects are attained with the invention having the characteristics presented below in the characterising parts of the independent claims. Some preferred embodiments of the invention are presented in the dependent claims.

The embodiments mentioned in this text relate, where applicable, to all aspects of the invention, even if this is not always separately mentioned.

A typical barrier coating structure according to the present invention for a sheet-like substrate comprising cellulosic and/or lignocellulosic fibres, comprises at least one first coating layer and at least one second coating layer, wherein the first coating layer is arranged in a direct contact with the second coating layer, and
the first coating layer comprises α-(1,3→glucan) polymer, and
the second coating layer comprises a cellulose ester and a polycarboxylic acid as a crosslinker.

A typical use according to the present invention of a barrier coating structure according to the present invention is for providing at least one barrier property, such as grease, oil and/or water barrier property when applied on a sheet-like product comprising cellulosic and/or lignocellulosic fibres.

A typical coated product according to the invention comprises
a substrate comprising cellulosic and/or lignocellulosic fibres, preferably a sheet-like substrate having a first large surface and a second large surface, which are parallel with each other, and
a barrier coating structure according to the present invention, applied on a surface of the substrate.

Now it has been surprisingly found that an effective, crack-resistant barrier coating structure is obtained by using a multilayer coating where the first, inner layer of the coating structure comprises α-(1,3→glucan) polymer and the second coating layer, i.e. the top coat, comprises a cellulose ester and a polycarboxylic acid. The barrier coating structure of the present invention shows significantly improved water resistance as well as a significant reduction in water vapour permeability. At the same time, the barrier coating structure shows excellent grease barrier properties and substantially improved oxygen barrier properties. In was unexpectedly found that a second coating layer comprising the cellulose ester and polycarboxylic acid could improve the water and moisture resistance of the coating structure without compromising the grease barrier properties obtained with the first coating layer.

The coating structure according to the present invention comprises at least one first coating layer and at least one second coating layer. It is possible, sometimes even preferable, that the first coating layer comprises two or more first sublayers and/or the second coating layer comprises two or more second sublayers. If the first coating layer comprises a plurality of first sublayers, the individual first sublayers are chemically identical with each other. If the second coating layer comprises a plurality of second sublayers, the individual second sublayers are chemically identical with each other. Chemically identical means that the sublayers of the said coating layer are made from same components in identical amounts, i.e. all sublayers are made by using identical coating formulation/solution. The coat weights of the individual first sublayers, as well as individual second sublayers, may vary. Use of a plurality of first and/or second sublayers enables the use of a low coat weight for individual sublayers while maintaining the barrier properties of the barrier coating structure. It is also possible to improve the barrier properties of the barrier coating structure by using a plurality of first and/or second sublayers, and to minimise the risk for coating defects. The first coating layer and the second coating layer of the barrier coating structure are preferably non-porous, i.e. first coating layer and the second coating layer of the barrier coating structure are both continuous layers.

The first coating layer is arranged in a direct contact with the second coating layer, which means that the second coating layer is applied directly on the surface of the first coating layer, in immediate and intimate contact with it. In case the first coating layer two or more first sublayers and the second coating layer comprise two or more second sublayers, one first sublayer is in direct contact with one second sublayer. The barrier coating structure is thus free of any intermediate layers between the first coating layer and the second coating layer.

The first coating layer comprises α-(1,3→glucan) polymer. In the present context the “α-(1,3→glucan) polymer” denotes a polymer having a polysaccharide backbone which comprises D-glucose units linked together by glycosidic linkages. At least 70%, preferably at least 80%, more preferably at least 90% or 95%, sometimes even of 99% or 100%, of the glycosidic linkages are α-1,3-linkages. This means that in the polysaccharide backbone the α-D-glucose units are connected to each other through carbons 1 and 3 on adjacent α-D-glucose rings. The form of glycosidic linkages can be determined by a person skilled in the art by using methods known as such, for example ¹HNMR. According to one embodiment of the invention the α-(1,3→glucan) polymer may have a degree of polymerization in a range of 55-7000, preferably 55-5000, more preferably 100-1000.

The polysaccharide backbone of the used α-(1,3→glucan) polymer may be linear, i.e. it may be unbranched. Alternatively, the α-(1,3→glucan) polymer may be branched. It is also possible that the linear or branched α-(1,3→glucan) polymer is crosslinked. Preferably α-(1,3→glucan) polymer is linear.

According to one embodiment the α-(1,3→glucan) polymer may be unsubstituted, i.e. α-(1,3→glucan) polymer is non-ionic and does not contain substituted charged groups. Preferably α-(1,3→glucan) polymer is unsubstituted, linear and non-crosslinked.

According to another embodiment the α-(1,3→glucan) polymer may be cationic, usually linear but possibly even crosslinked. The cationic α-(1,3→glucan) polymer comprises cationic substitution groups attached to its structure. The cationic substitution group may be a substituted ammonium group, preferably a quaternary ammonium group, more preferably a trialkyl ammonium group. Alkyl group in the trialkyl ammonium group may be, for example a methyl group, a hydroxymethyl group, a hydroxyethyl group or a hydroxypropyl group. The substituted ammonium group may be, for example, trimethylammonium group.

It is even possible the α-(1,3→glucan) polymer may be anionic, i.e. α-(1,3→glucan) polymer comprises anionic substitution groups attached to its structure.

The first coating layer may further comprise one or more additional agents selected from inorganic mineral pigments, rheology modifiers, pH regulating agents, dissolving pulp, cellulose, cellulose derivatives and/or polysaccharides, such as starch. For example, the first coating layer may comprise inorganic mineral pigments, which are selected from kaolin, talc, calcium carbonate or any mixture thereof, preferably calcium carbonate, such as ground calcium carbonate or precipitated calcium carbonate. The particle size D50 of the inorganic mineral pigment may be <5 μm. According to one embodiment the first coating layer may comprise inorganic mineral pigment, wherein at least 45% of the inorganic mineral pigment has a particle size <2 μm. Addition of inorganic mineral pigment to the first coating layer may further improve the obtained barrier properties of the coating structure and make it more economic to produce. Alternatively, or in addition, the first coating layer may comprise starch, which is degraded or non-degraded. The starch may be anionic starch.

The first coating layer preferably comprises at least 50 weight-%, more preferably at least 70 weight-%, even more preferably at least 90 weight-%, of the α-(1,3→glucan) polymer, calculated from the dry solids of the first layer. For example, the first coating layer may comprise 50-100 weight-%, preferably 70-99 weight-%, more preferably 90-99 weight-%, of the α-(1,3→glucan) polymer, calculated from the dry solids of the first layer. According to one preferable embodiment, the first coating layer may comprise 90-100 weight-% or 95-100 weight-%, of the α-(1,3→glucan) polymer, calculated from the dry solids of the first layer. The amount of additional agent(s) in the first coating layer may be 1-50 weight-%, preferably 1-30 weight-%, more preferably 1-10 weight-%, calculated from the dry solids of the first coating layer.

According to one embodiment α-(1,3→glucan) polymer is present in the first coating layer as dissolved. α-(1,3→glucan) polymer may be water-soluble, or it may be dissolvable in 4 weight-% NaOH solution or other basic solvent, e.g. KOH.

The second coating layer of the barrier coating structure comprises at least one cellulose ester. The cellulose ester is obtained by esterification reaction of cellulose, where hydroxyl groups of the cellulose are at least partially, or wholly, replaced by alkyl ester groups, such as acetyl, propionyl or butyryl. Cellulose ester may be selected from cellulose monoesters, cellulose diesters, cellulose triesters or any of their mixtures. The cellulose ester may comprise one type of alkyl ester groups or the cellulose ester may comprise two or more different types of alkyl ester groups. The cellulose ester suitable for use in the present invention may be selected from C1-C26 alkyl cellulose esters, preferably C1-C18 alkyl cellulose esters, more preferably C1-C10 alkyl cellulose esters, even more preferably C1-C6 alkyl cellulose esters, or any mixtures thereof. The alkyl ester groups of cellulose ester may be linear and/or branched. The alkyl ester groups of the cellulose ester may be saturated and/or unsaturated. It is also possible that the cellulose ester comprises other functional groups in addition to alkyl ester groups, such as phthalate groups, carboxylate groups and/or alkyl ether groups.

According to one preferable embodiment, the cellulose ester is selected from cellulose acetate, cellulose propionate, cellulose butyrate, cellulose stearate, cellulose acetate propionate, cellulose acetate butyrate, cellulose acetate phthalate or any mixture thereof, preferably from such as cellulose acetate, cellulose acetate butyrate, cellulose acetate propionate or any mixture thereof. By selection of the cellulose ester it is possible to modify the properties, e.g. hydrophobicity, of the second coating layer, and consequently the barrier coating structure. For example, the longer the alkyl chain is, the more hydrophobic and flexible the second coating layer is. Similarly, cellulose triesters are more hydrophobic compared to mono- and diesters since all of their accessible hydroxyl groups are replaced with non-polar ester groups.

According to one preferable embodiment the cellulose ester is or comprises cellulose acetate butyrate.

The second coating layer further comprises a polycarboxylic acid as a crosslinker. The crosslinker comprises at least two acid groups, which enable the effective crosslinking between the components of the second coating layer. The polycarboxylic acid is preferably selected from dicarboxylic acids, tricarboxylic acids or any mixtures thereof. The polycarboxylic acid may be selected, for example, from citric acid, isocitric acid, adipic acid, malic acid, succinic acid, acotinic acid, glutaric acid, oxalic acid, and any mixtures thereof, preferably from citric acid. Polycarboxylic acid may also be, for example, a homo- or copolymer of a monomer comprising carboxylic acid group(s), such as acrylic acid or maleic acid. The addition of polycarboxylic acid as crosslinker to the second coating layer provides a decrease in the water vapor and oxygen permeability for the barrier coating structure and improves the interfacial adhesion between the first and second coating layers.

The second coating layer may comprise 55-97 weight-%, preferably 65-95 weight-%, 70-90 weight-%, of the cellulose ester, calculated from total dry weight of the cellulose ester and the polycarboxylic acid.

The second coating layer may comprise 3-45 weight-%, preferably 5-35 weight-%, more preferably 10-30 weight-%, of the polycarboxylic acid, calculated from total dry weight of the cellulose ester and the polycarboxylic acid.

The second coating layer may yet further comprise a plasticizer. The presence of plasticizer is optional, but preferable. The plasticizer provides the second coating layer with increased flexibility, and it may even improve the obtained barrier properties of the coating structure. The plasticizer may be selected from any plasticizer compatible with the cellulose ester, such as various esters of dicarboxylic acid, such as citric acid esters and sebacic acid esters. For example, the plasticizer may be selected from triethyl citrate, tributyl citrate, acetyl triethyl citrate, dibutyl sebacate, diethyl phthalate, dibutyl phthalate, glycerol monostearate, triacetin and any mixtures thereof. Preferably the plasticizer is selected from dibutyl sebacate. It is possible to adjust the properties of the second coating layer by selection of the used plasticizer. For example, triethyl citrate is a hydrophilic plasticizer, which may improve the oil and grease resistance of the second coating layer. Tributyl sebacate is a hydrophobic plasticizer, which may improve the moisture barrier resistance of the second coating layer.

According to one embodiment the second coating layer may comprise the plasticizer in amount of 3-30 weight-%, preferably 5-27 weight-% or 7-25 weight-%, more preferably 10-25 weight-%, sometimes 12-20 weight-%, calculated from total dry weight of the second coating layer.

The coat weight of the first coating layer and the second coating layer in the barrier coating structure can be freely chosen depending on the desired end use and desired barrier properties. The second coating layer preferably has a total coat weight which is higher than the total coat weight of the first coating layer. According to one embodiment of the invention the first coating layer may have a total coat weight in a range of 4-20 g/m², preferably 5-19 g/m², more preferably 6-10 g/m². The second coating layer may have a total coat weight in a range of 2-20 g/m², preferably 4-16 g/m², more preferably 6-12 g/m². In case the first and/or second coating layers comprise two or more sublayers, their aggregate weight is within the given limits for the total layer weight for the first/second coating layer. The coat weights are given as coat weight per side or surface. It is possible that the substrate is coated only on one side with the barrier coating structure, or that all the surfaces of the substrate are coated with the barrier coating structure.

In some embodiments the surface of the substrate may be precoated, i.e. there may be one, two or more precoat layers between the substrate surface and the first coating layer of the barrier coating structure. For example, the substrate may be surface sized, e.g. with a layer of hydrophobic surface size, before application of the first coating layer. According to one embodiment of the invention, the first coating layer is applied directly on the surface of a substrate which is free from any precoat layers, such as surface sizing layers.

The barrier coating structure may have a total weight, including the weight of first layer(s) and the weight of the second layer(s), in a range of 6-40 g/m², preferably 9-35 g/m², more preferably 12-22 g/m². The first coating layer and the second coating layer may be applied on the surface of the substrate by using any conventional surface sizing or coating techniques, or their combinations. For example, the first coating layer of the barrier coating structure may be applied on the surface of the substrate by using rod coating, blade coating, spray coating or curtain coating. According to one embodiment, the second coating layer of the barrier coating structure may be applied on the first coating layer in a solution or dispersion form using any suitable coating technique, such as rod coating, blade coating, spray coating or curtain coating, or in a molten form by using extrusion coating. For example, the first coating layer can be applied by using a surface sizing device and the second coating layer may be applied by using a coating device, such as blade or rod coating device.

It is possible to apply one or more additional top coat layers on the second coating layer of the barrier coating structure, for example in order to modify the printing properties of the surface. According to one preferable embodiment, the second coating layer is free of any additional top coat layers, i.e. the second coating layer of the barrier coating structure forms the surface of the coated substrate.

The barrier coating structure according to the present invention is intended for substrates, especially sheet-like substrates, comprising cellulosic and/or lignocellulosic fibres. The cellulosic or lignocellulosic fibres may have been obtained by any conventional pulping process, including chemical, mechanical and chemi-mechanical pulping processes. The substrate may also comprise or consist of recycled fibres. When the substrate is sheet-like, it has a first and a second large surface, parallel with each other, and it is usually in form of a fibrous web. The substrate may have a grammage of 25-800 g/m², preferably 30-700 g/m², more preferably 40-500 g/m². The barrier coating structure may be applied at least on the surface of the substrate, e.g. on the first and/or the second large surface of a sheet-like substrate, by using any conventional surface sizing techniques or coating techniques, such as rod coating, blade coating, spray coating or curtain coating.

According to one embodiment of the invention the coated product comprises a sheet-like substrate comprising cellulosic and/or lignocellulosic fibres, such as paper, board or the like, and a barrier coating structure applied on the surface of the substrate. The surface of the substrate may be uncoated or coated with one of more precoats. According to one preferable embodiment, the first coating layer of the barrier coating structure is applied or arranged directly on the uncoated surface of the substrate, in immediate direct contact with the substrate. Furthermore, it is possible that the coated product comprises one or more additional top coat layers, arranged on top of the second coating layer of the barrier coating structure.

According to one embodiment the barrier coating structure and the substrate coated with the barrier coating structure may have a Cobb300 value in a range of 0.5-100 g/m², preferably 1-40 g/m², more preferably 2-20 g/m². The Cobb300 value is measured as described in the experimental section.

According to one embodiment the barrier coating structure and the substrate coated with the barrier coating structure may have TAPPI 559 KIT test value of at least 4, preferably at least 6. The KIT test value measures the repellency of the coating to oil and grease, and the measurements are performed according to standard TAPPI method T-559 pm-96.

According to one embodiment the barrier coating structure and the substrate coated with the barrier coating structure may have a mineral oil barrier HVTR value <100 g/m²/d. The used Hexane Vapour Transmission Rate (HVTR) value is obtained by using test method developed by BASF. In the test hexane is placed in a measurement cup covered by barrier sample, and the evaporation of hexane through the known area is measured. The test method is commonly known for persons skilled in the art.

According to one embodiment the barrier coating structure and the substrate coated with the barrier coating structure may have an oxygen barrier OTR value <400 g/(m²d), preferably <50 g/(m²d). OTR value can be measured by using standard methods of ASTM D-3985, F2622-08, F-1927, F-1307, ISO 15105-2:2003, DIN 53380.

According to one embodiment the barrier coating structure and the substrate coated with the barrier coating structure may have a water vapour transmission rate WVTR value in a range of 0.1-110 g/(m²·d), preferably 0.5-50 g/(m²·d), more preferably 1-30 g/(m²·d), at 23° C. and 50% relative humidity. WVTR value can be measured by using standard methods of ASTM F-1249, ISO 15105-2, ISO 15106-3, DIN 53122-2.

The substrate coated with the barrier coating structure according to the present invention can be used for making a foodservice package or for liquid packaging. Typical examples of foodservice packages are packages for fast food, ready-to-eat meals, sandwiches, bakery products, such as cookies, doughnuts, or the like.

### EXPERIMENTAL

Some embodiments of the invention are described in the following non-limiting examples.

### Preparation of Coating Solutions

The coating solution for the first coating layer was prepared as follows:

The coating solution comprising α-(1,3→glucan) polymer was prepared by dissolving 10 weight-% linear α-(1,3→glucan) polymer in 4 weight-% NaOH solution under magnetic stirring.

The coating solution for the second coating layer was prepared as follows:

The cellulose acetate butyrate (CAB) solution was prepared as 15 weight-% by dissolving CAB with 2.0 weight-% acetyl content, 47 weight-% butyryl content, 4.8 weight-% hydroxyl content and MWₙ of 20,000 g/mol in ethylene glycol diacetate (EGDA) at 60° C. under magnetic stirring. After complete dissolution, heating was turned off and dibutyl sebacate (DBS) was added. The solution was stirred for another 15 minutes, after which citric acid was added as an aqueous solution. The solution was stirred for another 15 minutes prior to coating.

The tested coating solutions for the second layer are given in Table 1.

TABLE 1
Coating solutions tested for the second layer. All
amounts are given as weight-%, calculated from
the total dry weight of the coating solution.

| Coating | Citric Acid | Dibutyl Sebacate | Cellulose Acetate |
|---|---|---|---|
| Solution | (weight-%) | (weight-%) | Butyrate (weight-%) |
| Coat 0 | 0 | 17 | 83 |
| (Reference) | | | |
| Coat 1 | 5 | 16 | 79 |
| Coat 2 | 9 | 15 | 76 |
| Coat 3 | 17 | 14 | 69 |
| Coat 4 | 23 | 13 | 64 |
| Coat 5 | 29 | 12 | 59 |
| Coat 6 | 17 | 19 | 64 |
| Coat 7 | 17 | 24 | 59 |

### Coating of Substrate

Uncoated paperboard, basis weight of 215 g/m², was used as a substrate.

The coating solutions were applied on the back side of the substrate by rod coating using RK Printcoat Instruments K Control Coater with coating speed 6.

The first coating layer comprising α-(1,3→glucan) polymer was first coated on the substrate with rod number 3. The coated sheet was dried at 50° C. for 2 minutes followed by neutralization with aqueous citric acid, described e.g. in U.S. Pat. No. 11,230,812. The neutralized sheets were dried at room temperature overnight before applying the second coating layer.

The second coating layer was coated on top of the neutralized α-(1,3→glucan) polymer layer using rod number 7 by using coating solutions defined in Table 1. The coating was then dried at 50° C. for 30 minutes followed by curing at 120° C. for 15 minutes. The coated sheets were conditioned overnight at 23° C. and 50% relative humidity (RH) according to ISO 187 before coating grammage determination and testing.

The coating grammage of the sheets was determined by die-cutting the sheets and comparing their weight to the uncoated substrate.

### Test Methods

### Cobb300, Water Resistance Test

Water absorption test was done based on ISO 535 standard. Test durations were 300 s. The unit for Cobb300 water resistance test result is g/m².

### Water Vapor Transmission Rate, WVTR

The water vapor transmission rate (WVTR) of the sheets was measured with Systech Illinois AquaSense Model 7101 Water Vapor Permeation Analyzer, the corresponding software being Systech Illinois 7101. This method conforms to standards ASTM F-1249, ISO 15105-2:2003, ISO 15106-3:2003 and DIN 53122-2. The WVTR measurement was performed at 23° C. and 50% RH using the MASK option with Extended Range, a ByPass time of 15 minutes and a Purge Level of 10. The results of this measurement are expressed as g/(m²d).

### KIT Grease Resistance Test

The grease resistance of the coated sheets was determined by the KIT test according to standard Tappi T559.

### Results

Results for the different coating structures are given in Table 2. It can be seen from Table 2 that use of a crosslinker in form of a polycarboxylic acid (citric acid) significantly improved WVTR values obtained for the coatings structures. At the same time Cobb300 values were maintained or even improved and no notable deterioration in measured KIT values could be observed. This indicates that the coating structure where a coating layer comprising α-(1,3→glucan) polymer is combined with a coating layer comprising cellulose ester and polycarboxylic acid is able to provide a mostly bio-based and food contact suitable alternative for petroleum-based barrier coatings. The coating structure of the invention could find use especially in fast food packaging, in which long-term barrier properties are not required.

TABLE 2
Results for the different coating structures tested.

| | | Coat | | | |
|---|---|---|---|---|---|
| | | Weight | | | |
| | Total | of 2^{nd} | | | |
| 2^{nd} | Coat | Coating | | | |
| Coating | Weight | Layer | Cobb300 | WVTR | |
| Layer | (g/m²) | (g/m²) | (g/m²) | (g/(m²d)) | KIT |
| Coat 0 | 17.8 | 9.8 | 9 | 149 | 7 |
| (Ref.) | | | | | |
| Coat 1 | 16.6 | 8.6 | 8 | 100 | 6 |
| Coat 2 | 14.6 | 6.6 | 10 | 65 | 7 |
| Coat 3 | 16.9 | 8.9 | 9 | 44 | 7 |
| Coat 4 | 18.1 | 10.1 | 13 | 20 | 4 |
| Coat 5 | 19.5 | 11.5 | 16 | 24 | 7 |
| Coat 6 | 19.4 | 11.4 | 11 | 25 | 6 |
| Coat 7 | 19.5 | 11.5 | 10 | 27 | 6 |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A barrier coating structure for a sheet-like substrate comprising cellulosic and/or lignocellulosic fibres, the barrier coating structure comprising at least one first coating layer and at least one second coating layer, wherein the first coating layer is arranged in a direct contact with the second coating layer, and
the first coating layer comprises α-(1,3→glucan) polymer, and
the second coating layer comprises a cellulose ester and a polycarboxylic acid as a crosslinker.

2. The barrier coating structure according to claim 1, wherein the polycarboxylic acid is selected from dicarboxylic acids, tricarboxylic acids and any mixtures thereof.

3. The barrier coating structure according to claim 1, wherein the cellulose ester is selected from C1-C26 alkyl cellulose esters, preferably C1-C10 alkyl cellulose esters, more preferably C1-C6 alkyl cellulose esters, and any mixtures thereof, such as cellulose acetate, cellulose acetate butyrate and cellulose acetate propionate.

4. The barrier coating structure according to claim 1, wherein the second coating layer comprises 55-97 weight-%, preferably 65-95 weight-%, 70-90 weight-%, of the cellulose ester, calculated from total dry weight of the cellulose ester and the polycarboxylic acid.

5. The barrier coating structure according to claim 1, wherein the second coating layer comprises 3-45 weight-%, preferably 5-35 weight-%, more preferably 10-30 weight-%, of the polycarboxylic acid, calculated from total dry weight of the cellulose ester and the polycarboxylic acid.

6. The barrier coating structure according claim 1, wherein the second coating layer comprises a plasticizer in amount of 3-30 weight-%, preferably 10-25 weight-%, more preferably 12-20 weight-%, calculated from total dry weight of the second coating layer.

7. The barrier coating structure according to claim 6, wherein the plasticizer is selected from triethyl citrate, tributyl citrate, acetyl triethyl citrate, dibutyl sebacate, diethyl phthalate, dibutyl phthalate, glycerol monostearate, triacetin and any mixtures thereof, preferably dibutyl sebacate.

8. The barrier coating structure according to claim 1, wherein the α-(1,3→glucan) polymer has a degree of polymerization in a range of 55-7000, preferably 55-5000, more preferably 100-1000.

9. The barrier coating structure according to claim 1, wherein the first layer comprises one or more additional agents selected from inorganic mineral pigments, rheology modifiers, pH regulating agents, dissolving pulp, cellulose, cellulose derivatives and polysaccharides, such as starch.

10. The barrier coating structure according to claim 1, wherein the first coating layer has a total coat weight in a range of 4-20 g/m², preferably 5-19 g/m², more preferably 6-10 g/m².

11. The barrier coating structure according to claim 1, wherein the second coating layer has a total coat weight in a range of 2-20 g/m², preferably 4-16 g/m², more preferably 6-12 g/m².

12. The barrier coating structure according to claim 1, wherein the barrier coating structure has a total weight of 6-40 g/m², preferably 9-35 g/m², more preferably 12-22 g/m².

13. The barrier coating structure according to claim 1, wherein the barrier coating structure has
a Cobb300 value in a range of 0.5-100 g/m², preferably 1-40 g/m², more preferably 2-20 g/m², and/or
a water vapour transmission rate, WVTR, value in a range of 0.1-110 g/(m²·d), preferably 0.5-50 g/(m²·d), more preferably 1-30 g/(m²·d), at 23° C. and 50% relative humidity.

14. A method for providing at least one barrier property, such as grease, oil and/or water barrier property, the method comprising:
applying the barrier coating structure according to claim 1 to a sheet-like product comprising cellulosic and/or lignocellulosic fibres.

15. A coated product comprising
a substrate comprising cellulosic and/or lignocellulosic fibres, preferably a sheet-like substrate having a first large surface and a second large surface, which are parallel with each other, and
a barrier coating structure according to claim 1, applied on a surface of the substrate.

16. The coated product according to claim 15, wherein the coated product comprises one or more precoat layers arranged between the surface of the substrate and the first coating layer of the barrier coating structure.

17. The coated product according to claim 15, wherein the coated product comprises one of more additional top coat layers, arranged on the second coating layer of the barrier coating structure.

18. The coated product according to claim 15, wherein the coated product is a foodservice package, such as package for fast food, ready-to-eat meals, sandwiches, bakery products, such as cookies, doughnuts, or the like.
